(19) United States
(12) Patent Application Publication
(10) Pub. No.: US 2011/0181624 A1
(43) Pub. Date: Jul. 28, 2011

(54) Interactive Publication and Associated Method of Displaying Community-Based Content Therewith

(76) Inventor: Daniel Michael Paul Nugara, Wayne, IL (US)

(21) Appl. No.: 12/694,104

(22) Filed: Jan. 26, 2010

(51) Int. Cl. G09G 5/10; G06F 15/16; G06F 1/32; B42D 1/00

(52) U.S. Cl. 345/690; 709/203; 713/323; 283/64

(57) ABSTRACT

The present disclosure relates generally to an interactive publication with a flexible cover browser and an associated tangible publication each with associated content, and more specifically, to a detachable browser-cover with a flexible computer screen, a proximity sensor, and power cells for enhancing a tangible publication such as a magazine by displaying associated content using a method of displaying community-based content. The disclosure also includes power-saving modes of operation of the detachable browser-cover, management of information within the memory of the device or uploaded from the Internet, and the associated technology.

### FIELD OF THE DISCLOSURE

The present disclosure relates generally to an interactive publication made of a flexible cover browser and an associated tangible publication each with associated content, and more specifically, to a detachable browser cover with a flexible computer screen, a proximity sensor, and power cells for enhancing a tangible publication such as a magazine by displaying associated content using a method of displaying community-based content, and a method of correcting the luminosity of a display using a tensile stress map felt by a touch screen layer mounted on the display.

### BACKGROUND

In the 1970s, the arrival of faxes, personal computers, and other electronic office equipment as a harbinger of the demise of paper in the workplace and as a news medium was frequently observed. In the early 1990s, the arrival of low-cost data storage media such as compact disks cause such predictions to resurface. For example, paper-based publications directed to video games were believed to be better served if sold in a digital format. With the arrival of the new millennium, all of these predictions proved at best premature, and paper-based publications remain in stores, stands, etc. The usefulness of paper-based publications is not only one of convenience but also increases product placement, readability, portability, and storage of information.

Newspapers are in a different category. The Internet, much like television, disseminates instant news whereas conventional newspapers can only report news a day late. As a result, some newspapers have seen a noticeable shift in demand while others providing financial news, specialized information, or difficult-to-access news see an increasing demand.

Books, magazines, posters, brochures, and the like also serve as marketing tools and reach a wider audience than digital information. Simply put, nothing can replace a hardcover magazine on the table of a dentist's waiting room. In one known example from the prior art, CDs with engraved digital information were packaged in a plastic casing and placed loosely inside of a plastic wrapper along with a magazine. The cover of these magazines often advertised the content of the CD as an added bonus, and sometimes the cover of these plastic casings also displayed images associated either with the digital content or with the magazine cover. The CD and its plastic casing can also be taped using transparent tape directly to a thicker magazine cover.

Plastic casings have recently been replaced with thin, plastified paper pouches taped to the cover of magazines or glued inside the binding of paper-based publication. An obvious problem with CDs is the need to use an external device to access the information contained in the CD. As such, the information on the CD does not truly enhance the tangible publication; it merely serves as a promotional supplement. What is needed is a system and device capable of providing the reader of a book directly with the digital content of the magazine with use of an external device to the magazine.

Other tools are known to provide readers of publications with some level of improved performance when a paper-based publication is read. For example, some 3D books are sold along with a pair of 3D glasses as an insert. The reader puts on the glasses as he/she reads the book. Another enhancement is the use of holographic portions or covers to give life to some of the illustrations in the publication. In one embodiment, a large, cover-size holographic poster is tack glued onto the cover of the magazine, which can later be placed on a wall. These enhancements, while limited in reach, are of great efficiency when directed to specific segments of the public.

U.S. patent application Ser. No. 11/743,647 illustrated at FIG. 1 from the prior art shows how a book such as a wedding album can be enhanced using a rigid, computerized device with a microprocessor. Once pictures are loaded into a memory of a computer processor, a series of buttons are used as the interface to navigate through the pictures stored in memory of the device. These devices are rigid and bulky and are not designed to enhance a given publication but on the contrary serve to replace the publication (e.g., a user will either watch the pictures on the screen or look at the paper-based pictures in the wedding album). U.S. Pat. No. 7,540,379 illustrated in FIG. 2 shows how a book can be hollowed and include connectors to an interface with a small portable device. The book can further include a speaker and an on/off switch. Though useful, these devices are costly and heavy and they transform the media to which they are attached.

Today, the era of handheld digital assistants, rigid computer-enabled tablets, and all-in-one phone/television/Internet cable connections is at hand. Tempting as they may be, these new-generation integrated services are all designed to put an end to paper-based tangible publications, not to enhance these publications. The inventor of the current invention has experience with the integration of novel technology with tangible publications to create an enhanced reading experience when applied to community-based directories and community-based information. U.S. patent application Ser. No. 11/464,646, filed Aug. 15, 2006, and entitled Method and Apparatus for Publishing a Community-Based Directory and Offering Associated Community-Based Services describes a first integrated package where a community-based directory is published using a tangible media, an Internet media such as a website, and is sent to phones over the WAP network. Two years later, on Mar. 17, 2008, the inventor applied for U.S. patent application Ser. No. 12/049,876 entitled Method and Apparatus for Digitizing a Paper-Based Publication where a community-based directory is collected and assembled and is then processed into both a paper-based publication, and several digital counterparts as part of an overall service package.

Chambers of Commerce, associations, and municipalities have operations that must also be addressed by technologies specifically tailored to their needs. Typically, these types of community-based entities are not as well equipped as corporations to compete in the marketplace with strong, corporate marketing departments. The leadership of community-based entities is often elected and changes periodically. Further, services provided to their electorate or members must be offered at a low cost. Directories and community-based information must constantly be updated and is subject to dynamic change as events take place and members come and go.

Some communities and groups have already created publications containing a wide range of information, which are not limited to community-based directories. What is needed is a method and apparatus to enhance and improve the market presence of communities that already have some degree of market exposure using both the paper-based industry and the digital-based industry as a single medium.

### SUMMARY

The present disclosure relates generally to an interactive publication with a flexible cover browser and an associated tangible publication each with associated content, and more specifically, to a detachable browser-cover with a flexible computer screen, a proximity sensor, and power cells for enhancing a tangible publication such as a magazine by displaying associated content using a method of displaying community-based content. The disclosure also includes power-saving modes of operation of the detachable browser-cover, management of information within the memory of the device or uploaded from the Internet, a method of correcting the luminosity to offset inherent changes in luminosity of a display using a tensile stress map felt by a touch screen layer.

### BRIEF DESCRIPTION OF THE DRAWINGS

Certain embodiments are shown in the drawings. However, it is understood that the present disclosure is not limited to the arrangements and instrumentality shown in the attached drawings wherein.

FIG. 1 is a digitally enhanced photo album taken from the prior art.

FIG. 2 is a paper-based publication with integrated digital device according to another device from the prior art.

FIG. 3 is a functional block diagram of the different contents produced from client input data according to an embodiment of the present disclosure.

FIG. 4 is a functional block diagram of the different network components for the transfer and display of digital based content according to another embodiment of the present disclosure.

FIG. 5 is a functional block diagram of the assembly facility for the creation of the interactive publication made of the browser cover and the associated paper-based publication according to an embodiment of the present disclosure.

FIG. 6 is an illustration of the interactive publication made of the browser cover and the paper-based publication according to an embodiment of the present disclosure.

FIG. 7 is an illustration of the browser cover taken from FIG. 6.

FIG. 8 is an exploded view of the browser cover of FIG. 7 according to an embodiment of the present disclosure.

FIG. 9 is a functional block diagram of the different components of the browser cover of FIG. 7 according to an embodiment of the present disclosure.

FIG. 10 is a functional block diagram of the different steps associated with a method of displaying content on the browser cover according to an embodiment of the present disclosure.

FIG. 11 is an illustration of the interactive publication made of the browser cover and the paper-based publication according to another embodiment of the present disclosure where the control bar is flattened to the thickness of the browser cover.

FIG. 12 is a method of using a tensile stress map felt in a touch screen layer to correct the luminosity of a display screen.

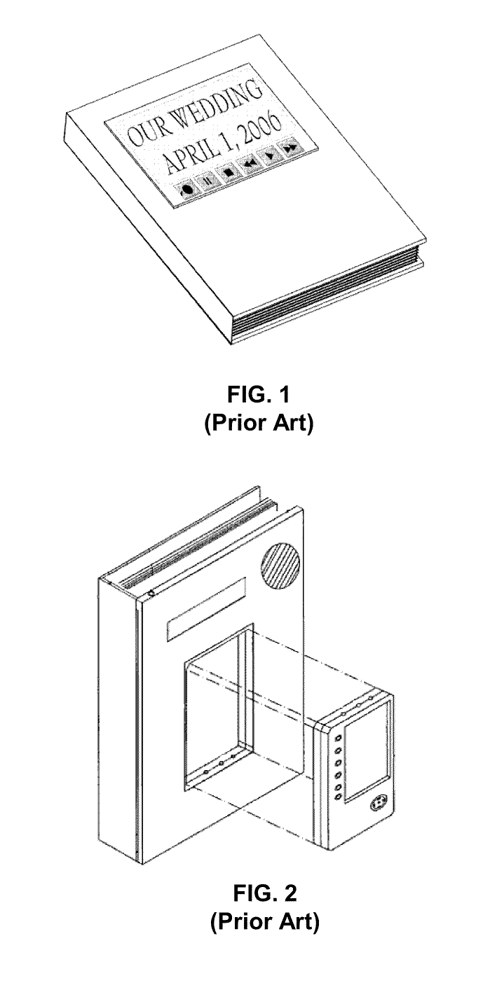

### DETAILED DESCRIPTION

The present invention is not limited to the particular details of the apparatus and method depicted, and other modifications and applications may be contemplated. Further changes may be made in the above-described device and method without departing from the true spirit and scope of the invention herein involved. It is intended, therefore, that the subject matter in the above depictions should be interpreted as illustrative, not in a limiting sense. It is understood by one of ordinary skill in the art that these different elements correspond to the general elements found in this disclosed system to practice this disclosure. Other auxiliary elements and limitations may be imagined and contemplated to operate the device and method, but they do not affect the validity and completeness of the disclosure of this device and method.

FIG. 6 is one possible illustration of an interactive publication 500 including a browser cover 310 placed upon a paper-based publication 501 using a fixation means such as clips 509 and adhesive 503 to secure a control bar 504 and the display 510 respectively forming the browser cover 310 to the paper-based publication 501. While one type of paper-based publication is shown, one of ordinary skill will understand that any known paper-based publication, including but not limited to hard bound volumes, soft bound volumes, spiral bound volumes, loose package of sheets, binders, newspapers, magazines, and the like many using any type of support, including but not limited to plastic, paper, glossy covers, laminated, brown paper, can be used. Fixation means 509, 503 as shown correspond also to only one of the many contemplated methods of attaching the browser cover 310 on the paper-based publication 501, such as for example the use of magnets, cuts in the paper cover, production of a paper-based publication with a unique mating shape to connect to the browser cover 310 and its control bar 504, the use of hooks and loops fasteners, adhesives, tape, and any and all other methods known in the print industry to attach a device on a paper-based publication 501.

The paper-based publication 501 as shown further includes a cover 507, a spine 508, and a cover surface 520 for the placement of information pertaining to the paper-based publication 501 for advertisement. While the interactive publication 500 is shown with only a single browser cover 310 on the front cover of the paper-based publication, what is contemplated is the use of one or several browser covers 310 located at the front, the side spine, the back cover, or any other surface used in the paper-based publication 501 for the display of information to the reader that is not part of the internal content of the paper-based publication 501.

As way of a non limiting example, some covers of magazines are folded inwardly and can be unfolded for a better cover effect, other covers are located in the mid-portion such as adult entertainment centerfolds that may be used as posters. The browser cover 310 while shown attached to the front cover of a paper-based publication 501, can be placed in any portion of the paper-based publication 501 including but not limited to the back cover 507, the spine 508, or any internal portion of the magazine.

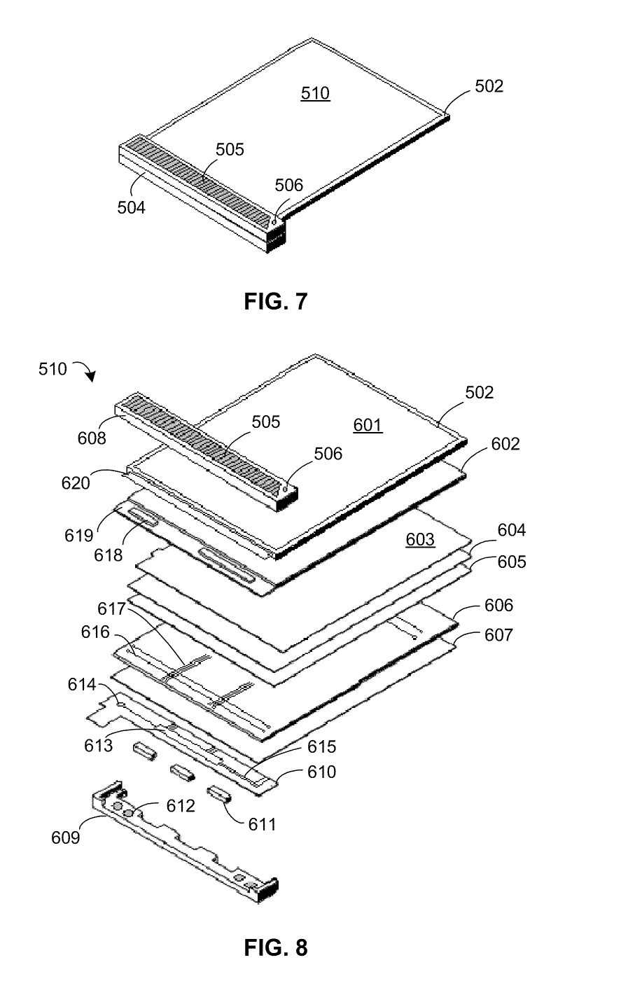

In one embodiment, craft magazines are sold to readers with a series of patterns and templates attached to different portions of the magazine, in this example, the browser cover 310 can be adapted to be used as part of these different portions of the magazines. FIG. 7 shows the browser cover 310 by itself without the paper-based publication as it is designed to be removable from the tangible publication and used manually or to be attached to a hanging surface or other flat surface for better viewing.

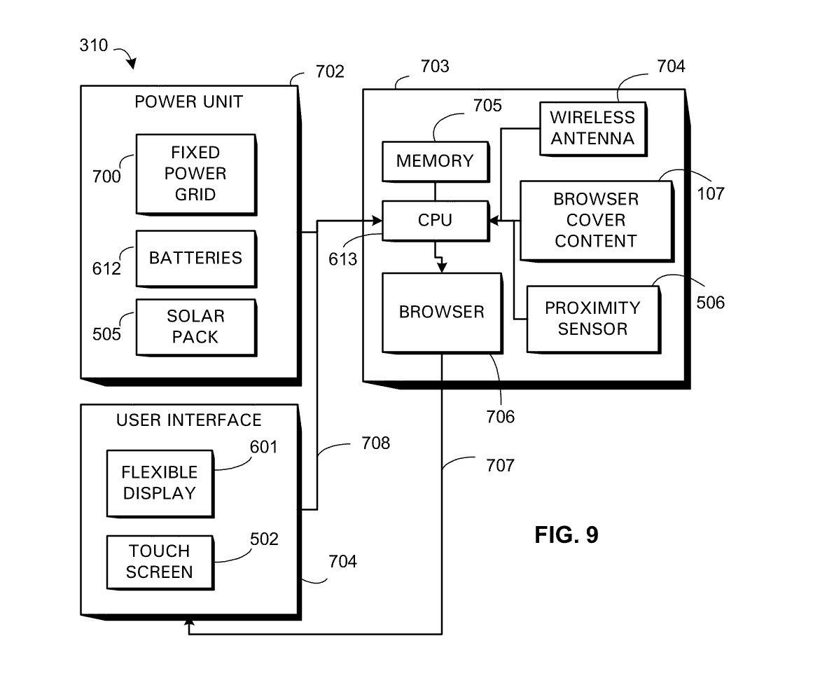

In one embodiment, the browser cover 310 includes solar/energy cells 505 or any other photon activated surface capable of transforming ambient activity into a power source, and a proximity sensor 506 directed outwardly to monitor movements within the close proximity of the browser cover 310. The browser cover 310 also may include a power switch (not shown) to energize the browser cover 310 and the associated control bar 504. The use of proximity sensors 506 and solar batteries can allow for the management of the energy stored in a power unit of the device 702 as shown at FIG. 9, or is also used during the management of the user interface 704. For example, an interactive publication 500 located on the table in a dentist waiting room will turn itself (i.e. close the retro light on the display) off after a fixed period of time is no sensor 506 activity is detected.

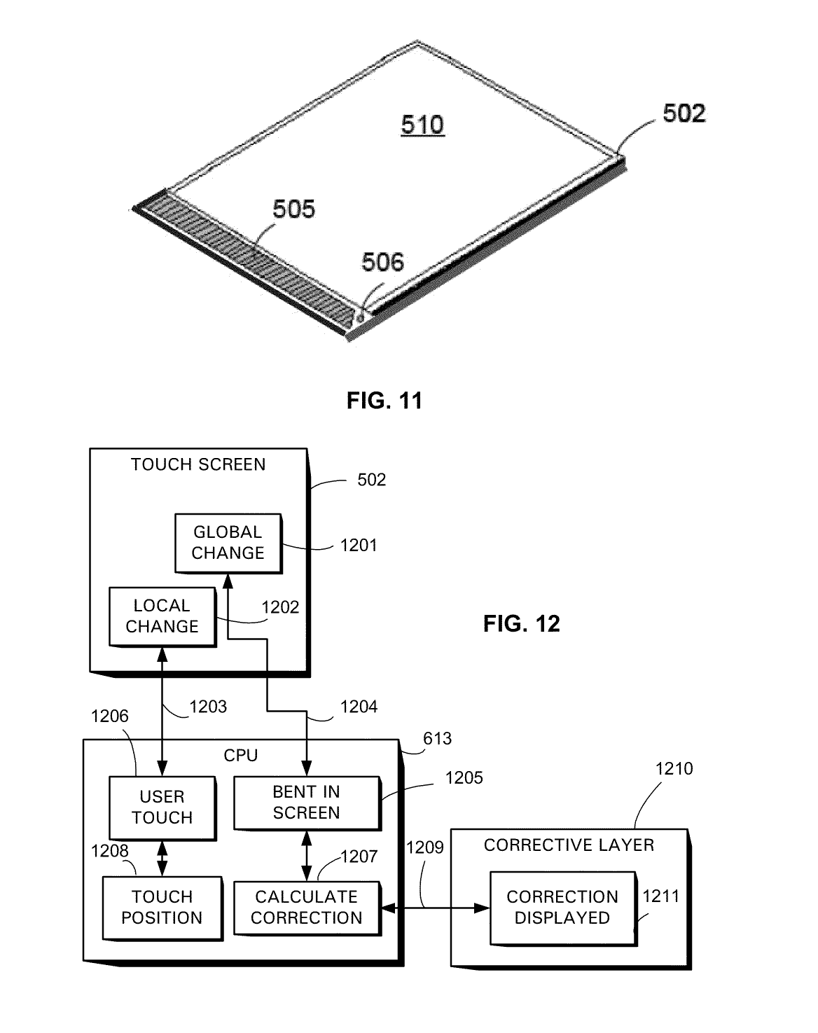

Generally FIG. 8 shows one possible internal configuration of the browser cover 310. The display is a liquid crystal display (LCD) having a light sensor disposed on a light polymer based flexible guide plate (LPFGP) where the brightness of the LCD is adjusted automatically with a brightness detector 614. A small bar shape casing 608 and 609 is shown to enclose the non flexible elements of the browser cover 310 in a first generation of technology. As the technology evolves and miniaturization reduces the size of each component, the size of the casing 608, 609 will be reduced and flattened until the thickness of the casing is the same as the display 510. This embodiment is shown as FIG. 11. Further, while a lateral bar shaped casing is shown 608, 609, what is contemplated is the placement of the essential components of the technology below or within the browser cover 310 at any position.

The user interface 703 is made of a flexible display 601 and in some embodiments a touch screen 502 layered on top of the flexible display 601 to manual activation of commands to the browser cover 310. LCD technology is generally a thin flat panel used for displaying electronic information such as text, images, and moving pictures. The LCD is lightweight, portable, and can be produced in any size needed, unlike a cathode ray tube. The low power consumption of the LCD enables it be powered by small power sources such as batteries, power cells, or even fixed power grids.

Generally in this technology, white light from a source, such as a white diode or a plurality of colored lights from several diodes or other sources, is placed adjacent to a medium capable of holding and transporting moving photons away from the source. This medium is called the light guide plate (LGP). The photons are channeled through the LGP to a partly transparent layer of liquid crystals that can be made of relative opacity via electronic control and thus colored. Several layers placed adjacent to the LGP are used to channel the photons through the liquid crystal layer, such as a back reflective surface not unlike a mirror, polarizing filters to block non-polarized light, and filters to remove some photons at specific wave lengths. At the heart of the transportation mechanism of light is a translucent or transparent material as they transport light across the volume through the crystals and outside of the display into the eye of a viewer of the LCD. For example glass, water, acrylic, polyethylene terephthalate (PET), silicone, or even polyimide can be used to serve as support for the light guide plate. In the above list, most often rigid glass or acrylic is used to form the non flexible light guide plate having improved transparency for a clearer image. The use of flexible material, such as PET, silicone or polyimide as described for example in U.S. Pat. No. 7,188,989, incorporated herein fully by reference allows for the creation of bendable 0.1 mm thin light guide plates. These flexible plates when mounted on flexible crystal layers, and plastic based filters create a fully flexible screen.

One of ordinary skill in the art recognizes that as a result of bending of a flexible light guide plate, portions of the plate and thus the travel path of light in the plate will result in distortions and phase changes in the polarized and filtered light ultimately resulting in a distortion in the image of the flexible screen. In initial stages small luminosity and color variations associated with curves and movements in the flexible screen are considered acceptable and require a user to flatten the screen for optimal use, such as placing the screen on a hard surface, a wall, a table or the like. In other uses, technologies can be used to correct the resulting distortion, including but not limited the use of a polymer layer used as the touch screen to determine a field of constraints at any point in the screen and associating with each point in the screen a light distortion created by a secondary layer of liquid crystal resulting from the calculation of an associated shape with the field of constraints.

Generally, two polarized filters at 90 degree are used to polarize entering and exiting light that may have shifted in phase as it moved through a substrate with electrodes. In further embodiments, a light sensor is electrically connected to a brightness control circuit by electrical lines arrange on a thin film transistor substrate. As the light sensor senses variations in the brightness of the external environment, such as day and night changes, it transmits a corresponding signal to the brightness control circuit. The light sensor can also serve as a proximity detector by assuming that no need for the device is required when all light is turned off (e.g. when the magazine is stacked against adjacent magazines in a pile). For example this technology is shown as part of U.S. Ser. No. 11/906,446 incorporated herein fully by reference.

Using the light sensor, the LCD can automatically adjust the display brightness according to variations in the brightness of the external environment, and provide optimal image display quantity to users with the use of a light detection sensor (not shown). Referring to FIG. 8, a touch screen 601 with a control interface 620 is placed upon an LCD panel 602 over a backlight module formed of elements 603, 604, 605, 606, and 607. In one embodiment, element 603 is an upper brightness enhancement film, element 604 is a bottom brightness enhancement film, element 605 a diffusion film, element 606 is the light polymer based flexible guide plate (LPFGP), and element 607 is the reflective plate. Light is produced by the light sources 611 encased in casing 609, 608, and aligned with the LPFGP.

What is also shown is a driving circuit 613 or other control PC processor connected to the LCD at either the guide plate layer (as shown) or the liquid crystal layer (not shown) or any other subsequent layer of the LCD screen by a series of conducting lines 615 connected to gate lines 616 and data lines 617 over a mother board 610. In one embodiment, as shown, batteries 612 can be placed into the casing 608, 609. The gate lines 616 and the data lines 617 all arranged on the mother board 610 are numerous and make the layout too complicated to show generally. Therefore, one of ordinary skill will understand that the representation is figurative and represents circuitry capable of connecting the different elements as known in the art. Also further portions of the inner circuitry, such as the driving chip for the driving circuitry, control chips for control modules, sensor and power unit control chips, port interfaces, wireless antenna connectors, or even the circuitry for the connection and calculation of touch screen technology is disclosed and not shown with specific details as they are known generally in the art of micro-electronics and are not germane to the novel aspect of the interactive publication 500.

Further, LCD technology is portable, has low power consumption, and low radiation. The use of LCD devices is widely used in various portable information products such as notebooks, personal digital assistants (PDAs), video cameras, tablets, phones, and the like. Normal LCD screens include a light guide, a source of light, optical films, a liquid crystal panel, and a support frame. In most LCDs, the frame encases the entire structure and includes a glass based light guide plate. Liquid crystal panels also include color filter substrates, thin film transistor substrate, a liquid crystal layer between the color filter substrate and the thin film transistor substrate and two polarizers.

The touch screen 601 as shown is known in the art of LCD. The system is a touch panel display that displays information and allows a user to interact with the system by touching on or near the displayed information. Several known technologies exist directed to a layer of polymer placed over or under a display layer of LCD and when touched, at least a portion of the layer is compressed and as a result this compression in the form of tensile stress or any other change in a characteristic is sent back to a plurality of detectors placed at the edge of a surface as shown for example in U.S. Pat. No. 6,690,363 incorporated fully herein by reference.

While one type of browser cover 310 is described above, what is contemplated is the use of any LCD technology with flexible light panel capable of creating a light, flexible, and portable screen with content can be displayed. The inventor has described and enabled one configuration of the technology of the browser cover 310 in broad technical description so that one of ordinary skill with not have to conduct undue experimentation to practice the invention.

The touch screen layer 502 is often a layer of polymer imbedded to either a side rail of detectors as shown in U.S. Pat. No. 6,690,363, or U.S. Pat. No. 5,196,836 also incorporated fully herein by reference. On this layer, the properties of the layer, such as conductibility or other characteristic are changed locally when the layer is under tensile stress. When a point located on the surface of the screen layer 502 is touched by a user, a variation is sent and recorded in the side rails and a software interface calculates a precise point on the screen associated with the change in property on the layer 502.

When a flexible display 601 is bent, the average thickness of the light guide layer LPFGP is reduced at different positions on the surface and the angles of the different layers next to the light guide are also changed, such as the angle of the polarizers, the deflectors, etc. As a result, a user will observe a change in the luminosity of the display 502 as the screen is bent. What is contemplated is the use of a tensile stress distribution or map as measured in the touch screen layer 502 that results from the bending of the display 510 as a base for the correction of the luminosity of the display 510.

As shown at FIG. 12, if the touch screen 502 of the browser cover display 510 is bent in an arc where, for example, the middle portion of the display is pushed upwards toward the reader, the middle portion of the display 510 is expanded along a curved line and either a lower density of light is reflected per surface area onto each crystal as a result of the bottom mirror being bent outwardly, or other local effect are observed. The CPU 613 will calculate based on the change type 1201, 1202 of the tensile stress distribution on the touch screen 502 if the change is local (e.g. only a small portion of the screen is touched corresponding to a user entry), or a global change (e.g. a large portion of the screen is bent corresponding to an overall change in the tensile stress map of the screen). If a user touch is found 1206 by the CPU 613, then the system will enter and recognize the user input associated with a touch position 1208 as known in ordinary modes of operation of touch screens 502. If the CPU 613 calculates that the screen is bent 1205, then a correction map 1207 is calculated to be sent 1209 to a corrective layer 1210 such as a layer of LCD with simply a density change for correction of the display 1211.

What is described is how an input, such as a tensile stress measured from a layer over the LCD, that can be measured for the determination of a correction to the LCD luminosity by measuring a global change, associating the change with a 2D map that can be superimposed to correct any measured variation in luminosity, and then sent for display correction using by use fo the polarized filters, by a second LCD display, or any other element capable of changing the reflective capacity of the mirror layer below the light guide.

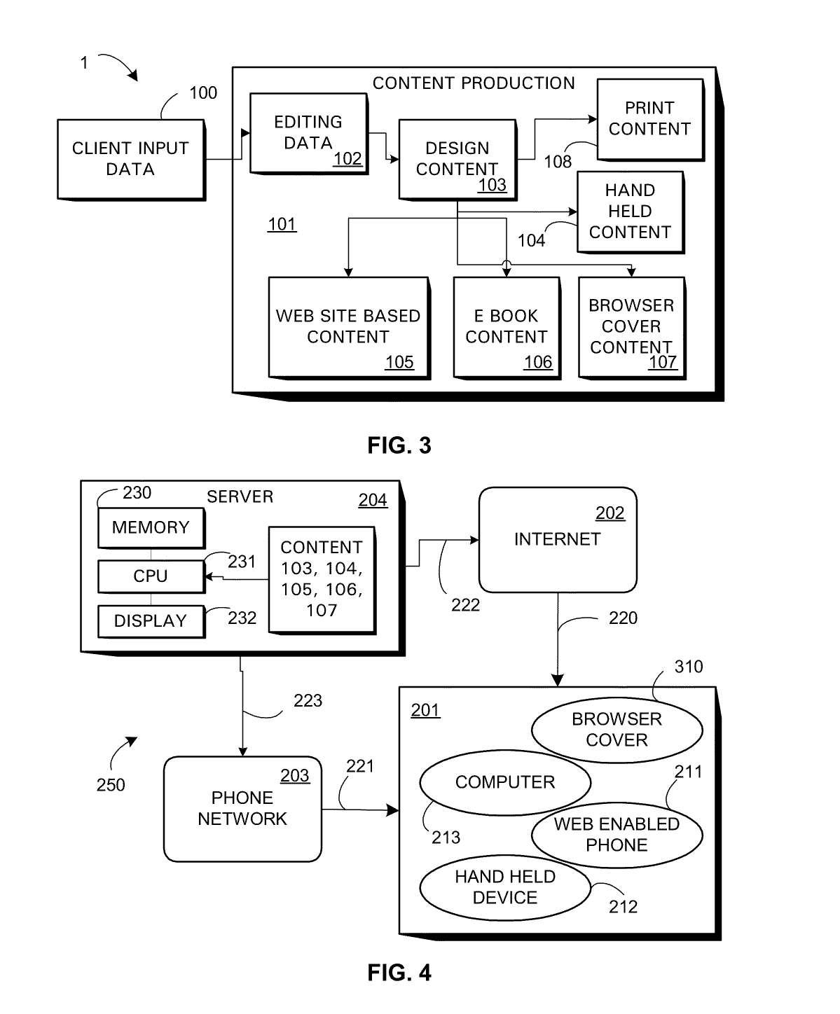

In addition to the hardware layer shown at FIGS. 6-8, several software layers are needed to operate the interactive publication 500. Turning to FIG. 3, the data from a client 100, such as community-based information or other type of information needed for the creation of a publication is then processed 1 in a content production center 101. This center as shown at FIG. 4 can be located on a server 204 such as for example an Internet 222 enabled server, a WAP enabled server 223, or a server capable to connect to any other type of client based interface 201 for the process of information.

One of ordinary skill in the art of management and collection of information will understand that software layers, such as page editing software, graphic software, layout software, dynamic JAVA or dynamic content creation software, or any other of a plurality of software applications can be used to edit the data 102. Another layer of software also residing in the memory 230 of a processor 231 and connected to a user interface with a display 232 processes the content into a viable design to any of a large quantity of selected media content. For example, at FIG. 3, a print content 108 can be prepared for dispatch to a publisher and a publishing print for the production of the book and its cover, another formatting can include handheld content 104 for example for personal digital assistants, the creation of web pages in HTML format or other format for the creation of content for web sites 105, the creation of Ebook content 106 or even content for the Browser Cover 107 to be used in the browser cover 310.

As a way of example, information can be collected from a Chamber of Commerce, a Municipality, from a University Student Body, or even from authors of a magazine as client data input 100, this information can be a collection of images, video clips, animations, portions of films, data, names, directories, and information regarding upcoming events, wanted adds, or even modern communication information such as networking information, navigation data, weather outlooks, etc. The information is then edited by the interface 102 before it processes to the content design phase 103. While the data editing 102 is shown as a step preceding the design of the content 103, one of ordinary skill in the art will appreciate that the design and editing of data and content can be performed as a mental step by the user of a software interface or using automatic editing and design tools based on the application. In the above example, the print content 108 can be a magazine format with a nice glossy cover, a community profile used as a tool to structure the information from a community such as a Chamber of Commerce into sections and subsections. As part of the print content, pages are fixed in size and must be managed accordingly. The same edited data can then be designed for web site based content 105 where dynamic links can be used judiciously between the different sections of the community profile. Web site design differs greatly from the paper-based media and the design also differs greatly for the same content. The same can be said for Ebooks who do not have large screens but can be stored in a memory chip for rapid download into a small portable device.

Handheld content 104, for example for a handheld device 212 or a web enabled phone 211, or a WAP phone over the phone network 203 have smaller displays, often of only several inches and must rely on a greater level of directory navigation to access information, resulting in a different design. For example, on handheld content, the user may be queried as to the capacity to store any image of the data in memory, access phone numbers and add them to the stored directory in the device, or use GPS enabled devices to locate themselves in relationship with the edited and designed content.

The browser cover content 107 as displayed by the browser cover 310 is designed to take advantage of the multi-media performance of a large screen, the capacity to display adds related to the content, to use screen savers of relationship with the content, and to help promote the content via a wireless connection to the Internet for either upload to a specific site such as the web site content 105 as implemented on the Internet 202 using a computer 210 as part of the display interface 201. In one embodiment, the browser cover content 107 is designed in a way quite analogous to the web site content 105 by using a locally mounted HTML or other Internet browser interface where the content is displayed and operated using the touch screen 502 on the flexible display 601 of the user interface 704 as shown at FIG. 9. In another embodiment, the browser cover content 107 is designed as a fully functional application that operates a fully dynamic interface to view all of the content of the edited data 102.

FIG. 4 illustrates how a server 204 that can be connected physically either wirelessly or via a ground line 222, 223 to the Internet 202, or a phone network 203 to access a user interface of any type 220, 221, for example as part of a computer 213, a browser cover 310, a web enabled phone 211, or a handheld device 212. While a handful of user interfaces and associated devices are listed 201, what is contemplated is the use of the disclosed interactive publication 500 in conjunction with any technology capable of uploading, editing, and designing content for the display the interactive publication 500 alone or in conjunction with other displayed content.

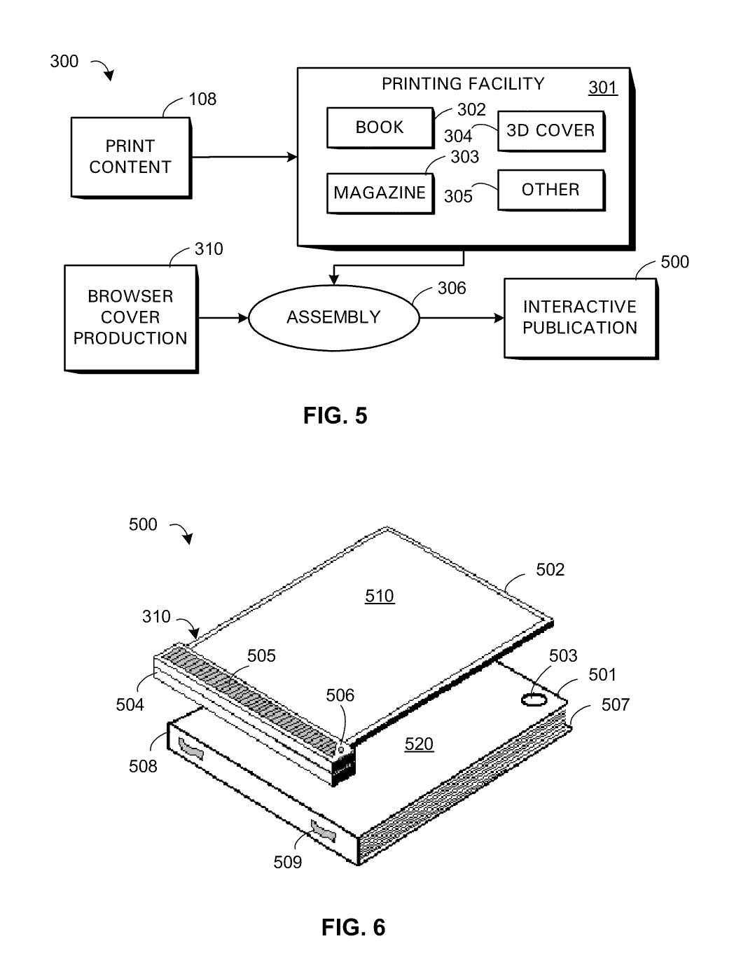

FIG. 5 illustrates how the print content 108 as shown at FIG. 3 is further processed to a printing facility 301 in order to produce either a book 302, a 3D cover 304, a magazine 303, or any other 305 type of paper-based publication that can be distributed and sold in the marketplace. Once the tangible publications are created, they are assembled 306 with a browser cover 310 from a production unit into the interactive publication 500 as shown at FIG. 6.

FIG. 9 shows the different electronic components of the browser cover 310, the device 703 includes a memory 705, a processor 613 connected to the memory for executing software such as a browser 706 or other software. In one embodiment, a wireless antenna 704 is connected to the CPU 613 with an internal connection for transfer of wireless data over the Internet between the browser cover 310 and the Internet. The browser cover also includes the content 107 located in memory and executed by the browser 706, and possibly a proximity sensor 506. As shown, an energy efficient power unit 702 may include a connection to a fixed power grid 700 of any known type, such as using a small power cable, internal batteries 612 with a limited life span, or a solar battery 505 for accumulation of energy. In one embodiment, several interactive publications 500 are stacked for delivery so no energy can be stored by the solar cells 505. In that case, the power unit 702 switches the power to the batteries 612 and executes a subroutine in the browser 706 for the display of information on the user interface 704 only if activity is sensed with the proximity sensor 506.

In another embodiment, once the browser cover 310 is detached and placed on a surface, the browser cover content can be displayed differently (e.g. no longer on a sales mode but on an informative mode). The browser 706 sends information 707 such as the content 107 to the user interface 704 at the flexible display 601 and possible also the touch screen 502. The power unit 702 is also either connected directly to the user interface 708 to provide energy or is connected to energize the processor 613 or any component of the device 703. While one configuration is shown, one of ordinary skill in the art of management of power in connection with small portable processors and associated equipment will understand that the suggested connections are only illustrative of one functional method of operation and other methods can be used.

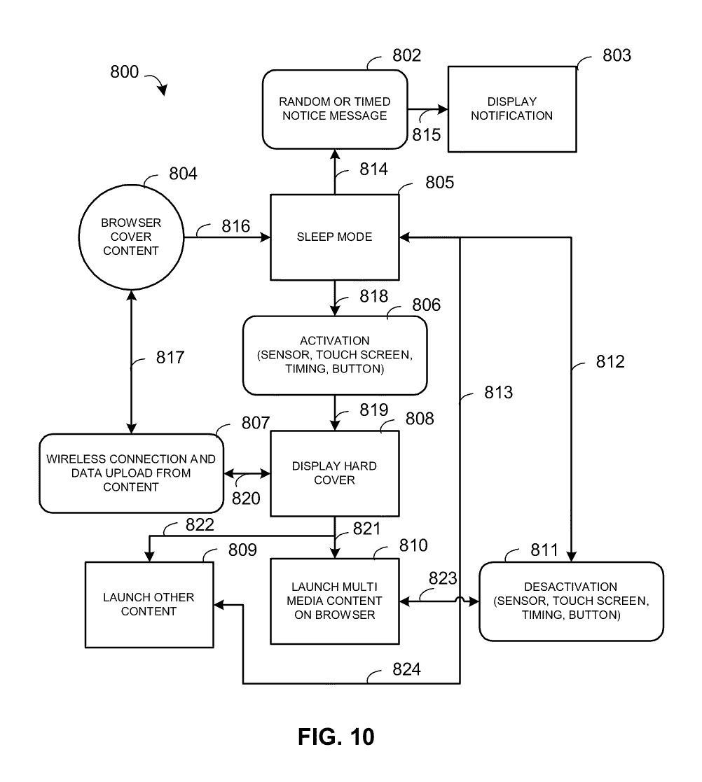

Finally, FIG. 10 displays a method 800 of displaying a community-based content or any other type of content using the interactive publication described herein. As described above, the display of the browser content may be in sleep mode 805 until it is activated 818 via the sensor, the touch screen, a timing function, or even an on and off switch 806. Once the display is activated, it displays 819 in one embodiment a display of the hard cover 808 of the paper-based publication on which the browser cover 310 is attached.

The user may then enable a wireless connection 820 and a data upload for display from the content 807 as shown at FIG. 4 either uploaded 817 from the browser content 804 or other content. When content is no longer uploaded, the device may be placed back 816 in sleep mode until it is activated 818 once again.

In an alternate embodiment, once the hard cover 808 is displayed, via user contact 822 other content from the browser cover content 107 is launched 809. Alternatively, the user may also access 821 other multi media content 810 such as the web site based content 105 or other content from for example advertisers in the interactive publication 500 on the browser. For example, while the browser cover content 107 may contain the data related to a specific restaurant, the user may either launch as an internal application 809 some part of the content stored in the memory 705 of the device, or connect wirelessly 807 to the server 204 to upload the same content if it is not in memory from the browser cover content 804 or ultimately browse all restaurants using another search engine 810. The user may then deactivate 811 at any step 810, 822, 808, or 807 of the display of content simply via the sensor, the touch screen, a timer, or even the on/off switch. As the device is deactivated, it returns 812 into the sleep mode 805 awaiting further action.

In yet another embodiment, such as to promote advertisement of the magazine sitting at a table, stored in a stack at a kiosk, a display 803 is notified or displayed 815 at random or once a timer elapses 802. Once again, while one method of operation of the device is described, one of ordinary skill will recognize the importance and usefulness of the disclosed embodiment and will understand all of the permutations and different ways of displaying information using the flexible screen display with or without the touch screen.

What is described is an interactive publication 500 with a paper-based publication 501 for holding a print content 108 from an input data 100, the paper-based publication including a cover surface 507, and a flexible browser cover 310 attached to the paper-based publication 501 with a fixation means. The browser cover 310 also includes a control bar 504 with a casing 608, 609 for holding a CPU or driving circuit 613 and a memory 705, an energy cell or a power unit 702 such as a solar pack 505, batteries 612, or a fixed power grid 700 for energizing the CPU 613.

The browser cover 310 further includes a proximity sensor 506, and a power switch for enabling the connection between the CPU 613 and the energy cell 702. In one embodiment, the browser cover 310 includes a backlight module comprising in a stackable configuration an upper brightness enhancement film 603, a bottom brightness enhancement film 604, a diffusion film 605, a light polymer based flexible guide plate 606, and a reflective plate 607. The light polymer based flexible guide plate 606 can include data lines 617, and gate lines 616 connected to a driving circuit 613 with a CPU on a mother board 610 via conducting lines 615.

In another embodiment, what is disclosed is a method of controlling the brightness of a flexible LCD panel 602 having a CPU 613 and a brightness detector 614 connected to the CPU 613, at least a light source 611 illuminating a light polymer based flexible guide plate 606, a layer 502 for measuring tensile stress on the LCD panel 602, and a corrective layer layered on the LCD display 510 such as the touch screen layer.

The method comprising the steps of measuring the ambient level of light for correcting the intensity of the light sources 611 based on a value at the brightness detector 614, making a first correction of the intensity of the light sources 611 based on a desired level of brightness for the ambient level of light, measuring a global change 1201 in the layer for measuring tensile stress 502 on the LCD panel, calculating 1207 using the CPU 613 a bend 1205 in the screen associated with the global change 1201, and displaying a correction 1211 of luminosity on the LCD display 510 by making a second correction of the intensity of the light sources by adding a displayed correction 1211 on the corrective layer 1210.

In one embodiment, the corrective layer 1210 is a touch screen 502 and the measured tensile stress is the measure of stress on the touch screen 502 as a result of a change in geometry of the touch screen and the LCD panel on which the touch screen is mounted.

In yet another embodiment, what is contemplated is a method for management of information as shown in FIGS. 3-5 over a system with a server 204 connected to the Internet 202 in data communication with a client based interface 201, the method comprising the steps of collecting input data 100 and editing the data 102 at a content production 101 on a server 204 with a memory 230, a CPU 231, and a display 231. The method further includes the step of using a software interface 103 operating in the memory 230 of the server 204 to produce content 103, 104, 105, 106, 107 from the client input data 100 for one of the plurality of client based interfaces 213, 212, 211, 310 including at least a browser cover content 107, and a print content 108. Finally assembling 306 an interactive publication as shown on FIG. 5 made from a browser cover 310 with the browser cover content 107 in a memory of the browser cover 310 and a paper-based publication taken from a printing facility 301 containing a print content 108. Further, the method includes the step of using the software interface operating in the memory of the server to produce content from the client input data 100 for at least one other client based interface 201 selected from a group consisting of a computer 213, a web enabled phone 211, and a handheld device 212.

Finally, in yet another embodiment, what is contemplated is an energy efficient method of operating an interactive publication 500 made of a paper-based publication 501 for holding a print content 108 from an input data 100, and a flexible browser cover 310 attached to the paper-based publication 501, the browser cover 310 including a control bar 504 with a casing 608, 609 for holding a CPU 613 and a memory 705, a display 510 for displaying a browser cover content 107, power 702 for energizing the CPU 613, a proximity sensor 506, a wireless antenna 704, a touch screen 601 over the display 502, and a power switch for enabling the connection between the CPU 613 and the power 702. The method also includes the steps of placing the display in a sleep mode 805, activating the CPU and the associated display 806 for displaying the browser cover content on the display at an activation, displaying a hard cover of the print content on the display 808, launching at the request of a user of the interactive publication other content 809, a multi media content portion of the browser cover content 810, or uploading content from a wireless connection via the wireless antenna 807, and finally resuming the sleep mode 805 after deactivation 811. In one embodiment, the activation is selected from a group consisting of a detection by the proximity sensor, a touch of the touch screen, an activation of a power button, and a first internal timer 806. In another embodiment, the deactivation is selected from a group consisting of the detection by the proximity sensor, the touch of the touch screen, the activation of the power button, and a second internal timer 811. Finally, the method includes the steps of placing a visual message 802 on the display for a display notification 803 at a random or a fixed period of time after activation of the sleep mode.

Persons of ordinary skill in the art appreciate that although the teachings of the disclosure have been illustrated in connection with certain embodiments, there is no intent to limit the invention to such embodiments. On the contrary, the intention of this application is to cover all modifications and embodiments falling fairly within the scope of the teachings of the disclosure.

What is claimed is:

1. An interactive publication, comprising: a paper-based publication for holding a print content from an input data, the paper-based publication including a cover surface, and a flexible browser cover attached to the paper-based publication with a fixation means, the browser cover including a control bar with a casing for holding a CPU and a memory, an energy cell for energizing the CPU, a proximity sensor, and a power switch for enabling the connection between the CPU and the energy cell.

2. The interactive publication of claim 1, wherein the browser cover includes a backlight module comprising in a stackable configuration an upper brightness enhancement film, a bottom brightness enhancement film, a diffusion film, a light polymer based flexible guide plate, and a reflective plate.

3. The interactive publication of claim 2, wherein the light polymer based flexible guide plate further includes data lines, and gate lines connected to a driving circuit on a mother board via conducting lines.

4. The interactive publication of claim 2, wherein the light polymer based flexible guide plate is made of a material selected from a group consisting of PET, silicone, and polymide.

5. The interactive publication of claim 1, wherein the fixation means is selected from a group consisting of an adhesive placed on the cover surface of the paper-based publication, a clip, magnets, a series of paper cuts made on the cover surface, hooks and loops fastener, and a tape.

6. The interactive publication of claim 1, wherein the paper-based publication is selected from a group consisting of a hard bound volume, a soft bound volume, a spiral bound volume, a loose package of sheets, a binder, a newspaper, and a magazine.

7. The interactive publication of claim 1, wherein the cover surface is made of a material selected from a group consisting of a plastic, a paper, glossy covers, a laminated paper, a brown paper.

8. The interactive publication of claim 1, wherein the browser cover is attached to the paper-based publication at a position selected from a group consisting of the front cover, the back cover, the spine, and an internal portion.

9. The interactive publication of claim 1, wherein the browser cover is attached to the front cover and includes a backlight module comprising in a stackable configuration an upper brightness enhancement film, a bottom brightness enhancement film, a diffusion film, a polymide based flexible guide plate with data lines, and gate lines connected to a driving circuit on a mother board via conducting lines, and a reflective plate, the fixation means is an adhesive placed on the cover surface, the paper-based publication is a magazine with a glossy cover.

10. A method of controlling the brightness of a flexible LCD panel having a CPU and a brightness detector connected to the CPU, at least a light source illuminating a light polymer based flexible guide plate, a layer for measuring tensile stress on the LCD panel, and a corrective layer layered on the LCD display, the method comprising the steps of:
measuring the ambient level of light for correcting the intensity of the light sources based on a value at the brightness detector;
making a first correction of the intensity of the light sources based on a desired level of brightness for the ambient level of light;
measuring a global change in the layer for measuring tensile stress on the LCD panel;
calculating using the CPU a bend in the screen associated with the global change; and
displaying a correction of luminosity on the LCD display by making a second correction of the intensity of the light sources by adding a displayed correction on the corrective layer.

11. The method of controlling the brightness of claim 10, wherein the corrective layer is a touch screen and the measured tensile stress is the measure of stress on the touch screen as a result of a change in geometry of the touch screen and the LCD panel on which the touch screen is mounted.

12. The method of controlling the brightness of claim 10, wherein the light sources are diodes.

13. The method of controlling the brightness of claim 10, wherein the light source illuminating a light polymer based flexible guide plate includes a layer made of polyimide.

14. A method for management of information over a system with a server connected to the Internet in data communication with a client based interface, the method comprising the steps of:
collecting input data and editing the data at a content production on a server with a memory, a CPU, and a display;
using a software interface operating in the memory of the server to produce content from the client input data for one of the plurality of client based interfaces including at least a browser cover content, and a print content; and
assembling an interactive publication made from a browser cover with the browser cover content in a memory of the browser cover and a paper-based publication from a printing facility containing a print content.

15. The method of claim 14, the steps further include the step of using the software interface operating in the memory of the server to produce content from the client input date for at least one other client based interface selected from a group consisting of a computer, a web enabled phone, and a handheld device.

16. An energy efficient method of operating an interactive publication made of a paper-based publication for holding a print content from an input data, and a flexible browser cover attached to the paper-based publication, the browser cover including a control bar with a casing for holding a CPU and a memory, a display for displaying a browser cover content, power for energizing the CPU, a proximity sensor, a wireless antenna, a touch screen over the display, and a power switch for enabling the connection between the CPU and the power, wherein the method comprises the steps of
placing the display in a sleep mode;
activating the CPU and the associated display for displaying the browser cover content on the display at an activation;
displaying a hard cover of the print content on the display;
launching at the request of a user of the interactive publication other content, a multi media content portion of the browser cover content, or uploading content from a wireless connection via the wireless antenna; and
resuming the sleep mode after deactivation.

17. The method of claim 16, wherein the activation is selected from a group consisting of a detection by the proximity sensor, a touch of the touch screen, an activation of a power button, and a first internal timer.

18. The method of claim 17, wherein the deactivation is selected from a group consisting of the detection by the proximity sensor, the touch of the touch screen, the activation of the power button, and a second internal timer.

19. The method of claim 16, further comprising the steps of placing a visual message on the display for a display notification at a random or a fixed period of time after activation of the sleep mode.

20. The method of claim 16, wherein the power is selected from a group consisting of a fixed power grid, a battery, and a solar pack.
